(19) United States
(12) Patent Application Publication
(10) Pub. No.: US 2025/0349844 A1
(43) Pub. Date: Nov. 13, 2025

(54) POSITIVE ELECTRODE ACTIVE MATERIAL, POSITIVE ELECTRODE INCLUDING POSITIVE ELECTRODE ACTIVE MATERIAL, AND NON-AQUEOUS ELECTROLYTE SECONDARY BATTERY INCLUDING POSITIVE ELECTRODE

(71) Applicant: Prime Planet Energy & Solutions, Inc., Tokyo (JP)

(72) Inventor: Shoji NONAKA, Takasago-shi (JP)

(21) Appl. No.: 19/195,735

(22) Filed: May 1, 2025

(30) Foreign Application Priority Data
May 8, 2024 (JP) 2024-075711

(51) Int. Cl. H01M 4/525; C01G 53/44; H01M 10/052

(52) U.S. Cl. CPC H01M 4/525; C01G 53/44; H01M 10/052; C01P 2002/50; C01P 2002/60; C01P 2002/74; C01P 2004/50; C01P 2004/61; C01P 2006/40

(57) ABSTRACT

A positive electrode active material includes secondary particles in each of which primary particles are aggregated, wherein each of the secondary particles is a lithium transition metal composite oxide having a lamellar crystal structure. The lithium transition metal composite oxide includes Li, Ni, Mn, Co, and M, and a molar ratio of the Li, the Ni, the Mn, the Co, and the M is Li:Ni:Mn:Co:M=a:x:y:z:t, where the M, the a, the x, the y, the z, and the t are defined as in the scope of claims for patent. An integrated intensity ratio (I₀₀₃/I₁₀₄) of diffraction peaks of the secondary particle in an X-ray diffraction method is 1.05 to 1.19. A crystallite size Loos of the secondary particle is 1000 Å or more.

### CROSS REFERENCE TO RELATED APPLICATIONS

This nonprovisional application is based on Japanese Patent Application No. 2024-075711 filed on May 8, 2024 with the Japan Patent Office, the entire contents of which are hereby incorporated by reference.

### BACKGROUND OF THE INVENTION

### Field of the Invention

The present invention relates to a positive electrode active material, a positive electrode including the positive electrode active material, and a non-aqueous electrolyte secondary battery including the positive electrode.

### Description of the Background Art

A lithium transition metal composite oxide used as a positive electrode active material of a non-aqueous electrolyte secondary battery greatly affects battery performance. It has been known that excellent battery performance is obtained by adjusting a crystal structure or the like of the lithium transition metal composite oxide (for example, Japanese Patent Laying-Open No. 2019-160801).

### SUMMARY OF THE INVENTION

An object of the present disclosure is to provide: a positive electrode active material to provide a non-aqueous electrolyte secondary battery having an excellent capacity retention in charging/discharging cycles and allowing for suppression of decreased discharging capacity; a positive electrode; and a non-aqueous electrolyte secondary battery.
[1] A positive electrode active material comprising secondary particles in each of which primary particles are aggregated, wherein
each of the secondary particles is a lithium transition metal composite oxide having a lamellar crystal structure,
the lithium transition metal composite oxide includes Li, Ni, Mn, Co, and M, the M being one or more metal elements selected from a group consisting of Mg, Ca, Al, Ti, V, Cr, Fe, Cu, Zn, Zr, Nb, Mo, Ta, and W,
a molar ratio of the Li, the Ni, the Mn, the Co, and the M is Li:Ni:Mn:Co:M=a:x:y:z:t, where the a, the x, the y, the z, and the t satisfy 1.0≤a≤1.3, x+y+z=1, 0.25≤x<0.9, 0<y≤0.6, 0<z≤0.6, and 0<t≤0.1,
an integrated intensity ratio (I₀₀₃/I₁₀₄) of diffraction peaks of the secondary particle in an X-ray diffraction method is 1.05 to 1.19, and
a crystallite size L₀₀₃ of the secondary particle is 1000 Å or more.
[2] The positive electrode active material according to [1], wherein the integrated intensity ratio ((I₀₀₃/I₁₀₄) is 1.16 or less.
[3] The positive electrode active material according to [1] or [2], wherein the M includes the W.
[4] The positive electrode active material according to any one of [1] to [3], wherein an average particle size (D50) of the secondary particles is 3 to 20 μm.
[5] The positive electrode active material according to any one of [1] to [4], wherein in each of the secondary particles, 50 or more primary particles are aggregated.
[6] A positive electrode using the positive electrode active material according to any one of [1] to [5].
[7] A non-aqueous electrolyte secondary battery comprising the positive electrode according to [6].

The foregoing and other objects, features, aspects and advantages of the present invention will become more apparent from the following detailed description of the present invention.

### DESCRIPTION OF THE PREFERRED EMBODIMENTS

In the present specification, a numerical range such as “x to y” includes the lower and upper limit values unless otherwise stated particularly. That is, “x to y” indicates a numeric value range of “x or more and y or less”. A numerical value freely selected from the numerical range may be employed as a new lower or upper limit value. For example, a new numerical range may be set by freely combining a numerical value described in the numerical range with a numerical value described in another portion of the present specification, a table, or the like.

### (Positive Electrode Active Material)

A positive electrode active material of the present embodiment is used for a positive electrode of a non-aqueous electrolyte secondary battery (hereinafter, also referred to as “secondary battery”) such as a lithium ion battery.

The positive electrode active material includes secondary particles in each of which primary particles are aggregated. Each of the secondary particles is a lithium transition metal composite oxide (hereinafter, also referred to as “composite oxide”) having a lamellar crystal structure. The composite oxide includes Li, Ni, Mn, Co, and M, the M being one or more metal elements selected from a group consisting of Mg, Ca, Al, Ti, V, Cr, Fe, Cu, Zn, Zr, Nb, Mo, Ta, and W, and a molar ratio of the Li, the Ni, the Mn, the Co, and the M is Li:Ni:Mn:Co:M=a:x:y:z:t, where the a, the x, the y, the z, and the t satisfy 1.0≤a≤1.3, x+y+z=1, 0.25≤x≤0.9, 0<y≤0.6, 0<z≤0.6, and 0<t≤0.1.

When the composite oxide includes the Li, the Ni, the Mn, and the Co, it means that the composite oxide includes a lithium element, a nickel element, a manganese element, and a cobalt element.

In the positive electrode active material, an integrated intensity ratio ((I₀₀₃/I₁₀₄) of diffraction peaks of the secondary particle in an X-ray diffraction method (hereinafter, also referred to as an “XRD method”) is 1.05 to 1.19, and a crystallite size L₀₀₃ of the secondary particle is 1000 Å or more.

Each of the secondary particles (hereinafter, also referred to as “the present secondary particle”) included in the positive electrode active material is an aggregated particle in which primary particles are aggregated. The number of the aggregated primary particles in the present secondary particle is preferably 50 or more, may be 100 or more, may be 1000 or more, and is 5×10⁶ or less in an ordinary case, and may be 5×10⁵ or less. The number of the aggregated primary particles in the present secondary particle can be adjusted in accordance with production conditions such as calcination conditions (a calcination temperature, the number of times of performing calcination, a calcination time, and the like) when producing the present secondary particles. The number of the aggregated primary particles included in each of the present secondary particles can be confirmed through, for example, an SEM image obtained by a scanning electron microscope (hereinafter, also referred to as “SEM”).

The present secondary particle is a composite oxide, and it can be confirmed by, for example, X-ray diffraction measurement or the like that the composite oxide has a lamellar crystal structure. An exemplary lamellar crystal structure of the composite oxide is a hexagonal structure (lamellar rock salt structure), a monoclinic structure, or the like. The composite oxide having the lamellar crystal structure promotes smooth intercalation and deintercalation of lithium ions.

Metal element M included in the composite oxide should include one or more of the above-described metal elements, but preferably includes at least the W (tungsten). When metal element M includes the W, a composite oxide having an integrated intensity ratio (I₀₀₃/I₁₀₄) and a crystallite size Loos in the above ranges is readily obtained.

The molar ratio of the Li is 1.0≤a≤1.3, may be 1.00≤a≤1.25, may be 1.01≤a≤1.20, may be 1.03≤a≤1.15, or may be 1.04≤a≤1.10. The molar ratio of the Ni is 0.25≤x≤0.9, may be 0.25≤x≤0.90, may be 0.30≤x≤0.90, may be 0.40≤x≤0.88, or may be 0.50≤x≤0.85. The molar ratio of the Mn is 0<y≤0.6, may be 0.00≤y≤0.60, may be 0.05≤y≤0.50, may be 0.08≤y≤0.30, or may be 0.10≤y≤0.20. The molar ratio of the Co is 0≤z≤0.6, may be 0.0≤z≤0.6, may be 0.0≤z≤0.5, may be 0.01≤z≤0.30, or may be 0.02≤z≤0.10. The molar ratio of the M is 0≤t≤0.1, may be 0.000≤t≤0.100, may be 0.000≤t≤0.080, may be 0.001≤t≤0.050, or may be 0.002≤t≤0.010. When the composite oxide includes two or more metal elements M, the molar ratio of the M refers to a total amount of the two or more metal elements.

The composition of the composite oxide can be adjusted in accordance with types of source materials used when producing the composite oxide and a blending amount of the source materials. The composition of the composite oxide can be found by ICP (Inductively Coupled Plasma) atomic emission spectrometry (ICP-AES). More specifically, measurement can be performed in accordance with the general rules for atomic emission spectrometry in JIS K 0116:2014, and for example, the composite oxide is dissolved in accordance with an alkali melting method, is diluted to a predetermined amount with ultrapure water, tartaric acid, or hydrochloric acid, and is analyzed by using a high-resolution ICP atomic emission spectrometer (“PS3500DDII” provided by Hitachi High-Tech Corporation). Respective wavelengths of the elements to be measured in the ICP-AES can be as follows: Li: 670.784 nm; Co: 238.892 nm; Mn: 257.61 nm; and Ni: 231.604 nm.

The integrated intensity ratio (I₀₀₃/I₁₀₄) of the diffraction peaks of the present secondary particle is 1.05 to 1.19, may be 1.06 to 1.18, may be 1.08 to 1.17, or may be 1.10 to 1.15. The integrated intensity ratio (I₀₀₃/I₁₀₄) is preferably 1.05 to 1.16, and is more preferably 1.06 to 1.15. When the integrated intensity ratio (I₀₀₃/I₁₀₄) exceeds the above range, crystal growth of the primary particles is promoted in the process of producing the secondary particle and the secondary particle is likely to be cracked, with the result that the capacity retention of the secondary battery in the charging/discharging cycles is likely to be decreased. Since the integrated intensity ratio (I₀₀₃/I₁₀₄) of the present secondary particle falls within the above range, the present secondary particle is less likely to be cracked. Therefore, by using the present secondary particle, a secondary battery having an excellent capacity retention in the charging/discharging cycles can be readily obtained.

Integrated intensities I₀₀₃ and I₁₀₄ of the diffraction peaks of the present secondary particle in the XRD method are respective integrated intensities of the diffraction peaks of the secondary particle at a (003) plane and a (104) plane as measured by the XRD method, and can be measured by a method described in Examples described later. The integrated intensity ratio (I₀₀₃/I₁₀₄) of the present secondary particle can be adjusted in accordance with, for example, production conditions such as an amount of addition (blending ratio) of lithium, the compositions of the source materials, and the calcination conditions (the calcination temperature, the number of times of performing calcination, the calcination time, and the like) when producing the present secondary particle.

Crystallite size L₀₀₃ of the present secondary particle is 1000 Å or more, may be 1010 Å or more, may be 1020 Å or more, may be 1000 to 3000 Å, may be 1010 to 2500 Å, may be 1020 to 2000 Å, or may be 1020 to 1500 Å. When the integrated intensity ratio (I₀₀₃/I₁₀₄) falls within the above range, a Li site occupancy in the transition metal layer of the secondary particle is likely to be large, with the result that the discharging capacity of the secondary battery is likely to be decreased. However, when crystallite size L₀₀₃ of the present secondary particle falls within the above range, the Li site occupancy can be small, with the result that the discharging capacity of the secondary battery can be suppressed from being decreased.

Crystallite size L₀₀₃ of the present secondary particle can be calculated from the half width of the diffraction peak of the secondary particle at the (003) plane as measured by the XRD method, and can be calculated by a method described in Examples described later. Crystallite size L₀₀₃ of the present secondary particle can be adjusted in accordance with the production conditions such as the amount of addition (blending ratio) of lithium, the compositions of the source materials, and the calcination conditions (the calcination temperature, the number of times of performing calcination, the calcination time, and the like) when producing the present secondary particle.

The average particle size (D50) of the secondary particles is preferably 3 to 20 μm, may be 5 to 18 μm, or may be 8 to 15 μm. When the average particle size (D50) of the secondary particles falls within the above range, a secondary battery having an excellent capacity retention in the charging/discharging cycles and allowing for suppression of decreased discharging capacity can be readily obtained. In the present specification, the average particle size is a particle size (D50) corresponding to 50% of cumulation of frequencies from the smallest particle size in a volume-based particle size distribution. The volume-based particle size distribution can be measured by a laser diffraction type particle size distribution measurement apparatus.

The positive electrode active material should include the present secondary particles, and the positive electrode active material may include only the present secondary particles, or may include particles (hereinafter, also referred to as “other particles”) other than the present secondary particles, for example. The content of the present secondary particles in the positive electrode active material is, for example, 70 to 100 mass %, may be 85 to 98 mass %, or may be 90 to 95 mass %, when the total amount of the positive electrode active material is regarded as 100 mass %. Each of the other particles that may be included in the positive electrode active material may be a single particle or may be a secondary particle (hereinafter, also referred to as “other secondary particle”) other than the present secondary particle. The single particle may be a lithium transition metal composite oxide having a lamellar crystal structure, and the composition thereof may fall within the range of the composition described with regard to the present secondary particle, or may fall out of the range of the composition. The other secondary particle may be a secondary particle having a composition falling out of the above range of the composition described with regard to the present secondary particle, may be a secondary particle falling out of the above range of the integrated intensity ratio (I₀₀₃/I₁₀₄), or may be a secondary particle falling out of the above range of crystallite size L₀₀₃.

The present secondary particle can be obtained, for example, in the following manner: a compound (hereinafter, also referred to as “NiMnCo-containing precursor”) including Ni, Mn, and Co, a lithium compound, and, as required, an M-containing compound including metal element M are mixed to obtain a mixture and the mixture is calcinated. Alternatively, the secondary particle may be obtained in the following manner: a Ni-containing compound including Ni, a Mn-containing compound including Mn, a Co-containing compound including Co, a lithium compound, and an M-containing compound including metal element M are mixed to obtain a mixture and the mixture is calcinated. Each of the Ni-containing compound, the Mn-containing compound, and the Co-containing compound may include metal element M.

Examples of the NiMnCo precursor include a composite oxide or composite hydroxide containing Ni, Mn, and Co. Examples of the lithium compound include lithium hydroxide, lithium carbonate, or the like. Examples of the M-containing compound include an ammonium compound including metal element M, or the like.

### (Positive Electrode)

A positive electrode of the present embodiment is formed using the above-described positive electrode active material. According to the positive electrode of the present embodiment, it is possible to provide a non-aqueous electrolyte secondary battery having an excellent capacity retention in the charging/discharging cycles and allowing for suppression of decreased discharging capacity.

The positive electrode can have a positive electrode current collector foil and a positive electrode active material formed on one surface or each of both surfaces of the positive electrode current collector foil. The positive electrode active material is included in a positive electrode active material layer, and the positive electrode active material layer can further include at least one of a binder and a conductive auxiliary agent. The positive electrode active material layer can be formed in the following manner: a positive electrode slurry obtained by adding a solvent such as N-methyl-2-pyrrolidone (NMP) to the materials for forming the positive electrode active material layer, such as the positive electrode active material, the binder, and the conductive auxiliary agent is applied to the positive electrode current collector foil, which is then dried and compressed.

The positive electrode current collector foil is, for example, a metal foil formed using an Al material such as Al or an Al alloy. Examples of the binder includes: a fluororesin such as polyvinylidene difluoride or polytetrafluoroethylene; a cellulose-based resin such as carboxymethyl cellulose, methyl cellulose, and hydroxypropyl cellulose; and styrene-butadiene rubber, and one or more of these can be used. Examples of the conductive auxiliary agent include a carbon material. Examples of the carbon material include a fibrous carbon such as a carbon nanotube, carbon black, and the like, and one or more of these can be used.

### (Non-Aqueous Electrolyte Secondary Battery)

A non-aqueous electrolyte secondary battery (hereinafter, also referred to as “the present battery”) of the present embodiment has the positive electrode described above. The present battery can include an electrode assembly including the positive electrode, and a non-aqueous electrolyte solution, and may have a battery case that accommodates the electrode assembly and the non-aqueous electrolyte solution. The battery case may include: an exterior package provided with an opening; and a sealing plate that seals the opening. Each of the exterior package and the sealing plate is preferably composed of a metal, and can be formed using aluminum, an aluminum alloy, iron, an iron alloy, or the like. A resin sheet serving as an electrode holder may be disposed between the electrode assembly and the exterior package. Moreover, the battery case may be made of a laminate film. The laminate film has, for example, a stacking structure in which a metal layer and a resin layer are stacked. Edge portions of the laminate film are overlapped and welded, thereby forming the battery case in the form of a pouch.

The electrode assembly may include the above-described positive electrode, a negative electrode, and a separator. In the electrode assembly, the positive electrode active material layer of the positive electrode and a negative electrode active material layer of the negative electrode face each other with the separator being interposed therebetween. The electrode assembly may be of a stacked type in which the positive electrode, the negative electrode, and the separator are stacked, or may be of a wound type in which a strip-shaped stack in which a strip-shaped positive electrode, a strip-shaped negative electrode, and a strip-shaped separator are stacked is wound. The wound type electrode assembly may have a flat shape due to pressing after winding the stack.

Generally, the negative electrode has a negative electrode current collector foil and a negative electrode active material layer, and the negative electrode current collector foil is, for example, a metal foil formed using a copper material such as copper and a copper alloy. The negative electrode active material layer includes a negative electrode active material and may further include a conductive auxiliary agent, a binder, and the like. The negative electrode active material layer can be formed in the following manner: a negative electrode slurry obtained by adding a solvent such as water to the materials for forming the negative electrode active material layer, such as the negative electrode active material, the binder, and the conductive auxiliary agent is applied to the negative electrode current collector foil, which is then dried and compressed.

Examples of the negative electrode active material include a carbon-based active material such as graphite, and a metal-based active material such as Si, SiOx, or a composite of Si and C, or Sn, and one or more of these can be used. Examples of the binder include the above-described cellulose-based resin, polyacrylic acid, styrene-butadiene rubber, and the like, and one or more of these can be used. Examples of the conductive auxiliary agent include those described above.

The separator has a base member and may have a functional layer on at least one surface of the base member. The base member can be a porous sheet such as a film or nonwoven fabric composed of a resin such as: polyolefin such as polyethylene and polypropylene; polyester; cellulose; or polyamide. The base member may have a single-layer structure or a multilayer structure, and in the case of the multilayer structure, the materials of the respective layers may be the same or different. Examples of the functional layer include an adhesive layer formed by an adhesive agent, and a heat-resistant layer including an inorganic filler, a binder, and the like.

In the non-aqueous electrolyte solution, an electrolyte is preferably contained in a non-aqueous solvent such as an organic solvent. Examples of the electrolyte include LiPF₆, LiBF₄, LiClO₄, LiFSO₃, and LiBOB, and one or more of these can be used. Examples of the non-aqueous solvent include ethylene carbonate, ethyl methyl carbonate, dimethyl carbonate, propylene carbonate, butylene carbonate, diethyl carbonate, and the like, and one or more of these can be used.

### EXAMPLES

Hereinafter, the present disclosure will be described more specifically with reference to examples and comparative examples.

### Examples 1 to 4 and Comparative Examples 1 to 6

### (Production of Lithium Transition Metal Composite Oxide)

A NiMnCo-containing precursor including Ni, Mn, and Co at a ratio of Ni:Mn:Co-83:12:5 (molar ratio), lithium hydroxide monohydrate, and ammonium paratungstate were mixed to obtain a mixture. The lithium hydroxide monohydrate and the ammonium paratungstate were mixed such that Li and W were included in terms of the number of moles shown in Table 1 with respect to 1 mol (that is, Ni: 0.83 mol, Mn: 0.12 mol, Co: 0.05 mol) as the total number of moles of Ni, Mn, and Co in the NiMnCo-containing precursor. After the mixture was introduced into a crucible composed of alumina, the crucible was placed in an electric furnace to calcinate the mixture, thereby obtaining a lithium transition metal composite oxide. The calcination of the mixture was performed in the following manner: while measuring a temperature with an alumina-coated K thermocouple being inserted in the mixture inside the crucible, heating is first performed to 500° C. at an oxygen flow rate of 4 L/min and a temperature increasing rate of 5° C./min, holding was performed at 500° C. for 3 hours, heating was then performed to a temperature of Tmax shown in Table 1 at a temperature increasing rate of 5° C./min, and holding was performed at the temperature of Tmax for 10 hours. The lithium transition metal composite oxide was observed with a scanning electron microscope to find that the lithium transition metal composite oxide was a secondary particle in which the number of aggregated primary particles was 50 or more.

TABLE 1

| | NiMnCo-Containing | The Number of Moles with respect to 1 mol | | |
|---|---|---|---|---|
| | Precursor | as the Total Number of Moles of Ni, Mn, and | | |
| | Ni:Mn:Co | Co in NiMnCo-Containing Precursor | | Tmax |
| | (Molar Ratio) | Li [mol] | W [mol] | [° C.] |
| Example 1 | 83:12:5 | 1.06 | 0.005 | 805 |
| Example 2 | 83:12:5 | 1.05 | 0.005 | 815 |
| Example 3 | 83:12:5 | 1.09 | 0.009 | 805 |
| Example 4 | 83:12:5 | 1.12 | 0.009 | 815 |
| Comparative | 83:12:5 | 1.03 | 0.005 | 795 |
| Example 1 | | | | |
| Comparative | 83:12:5 | 1.03 | 0 | 795 |
| Example 2 | | | | |
| Comparative | 83:12:5 | 1.06 | 0.009 | 805 |
| Example 3 | | | | |
| Comparative | 83:12:5 | 1.09 | 0.009 | 815 |
| Example 4 | | | | |
| Comparative | 83:12:5 | 1.06 | 0 | 805 |
| Example 5 | | | | |
| Comparative | 83:12:5 | 1.09 | 0.005 | 815 |
| Example 6 | | | | |

(Production of Positive Electrode)

A positive electrode was prepared using, as a positive electrode active material, the lithium transition metal composite oxide obtained above. The positive electrode active material, acetylene black (AB) serving as a conductive auxiliary agent, and polyvinylidene difluoride (PVdF) serving as a binder were prepared at a ratio of the positive electrode active material: AB:PVdF=100:1:1 (mass ratio), and these were mixed with N-methyl-2-pyrrolidone (NMP) to prepare a positive electrode slurry. The positive electrode slurry was applied to an aluminum foil serving as a positive electrode current collector foil, which was dried, compressed, and then cut into a predetermined size to obtain the positive electrode.

### (Production of Negative Electrode)

A negative electrode active material, which was a mixture of graphite and SiO, was prepared, and styrene-butadiene rubber (SBR) and carboxymethyl cellulose (CMC) were prepared as a binder. The negative electrode active material, the SBR, and the CMC are prepared at a ratio of the negative electrode active material: SBR:CMC=100:1:1 (mass ratio), and these are mixed with water to prepare a negative electrode slurry. The negative electrode slurry was applied to a copper foil serving as a negative electrode current collector foil, which was dried, compressed, and then cut into a predetermined size to obtain a negative electrode.

### (Preparation of Non-Aqueous Electrolyte Secondary Battery)

A separator having a three-layer structure of polypropylene/polyethylene/polypropylene was prepared. The positive electrode and the negative electrode were stacked with the separator being interposed therebetween, thereby obtaining an electrode assembly. A positive electrode tab, which was formed by the aluminum foil of the positive electrode current collector foil at a region at which the positive electrode active material layer was not formed, and a negative electrode tab, which was formed by the copper foil of the negative electrode current collector foil at a region at which the negative electrode active material layer was not formed, were exposed respectively at both end portions of the electrode assembly. The positive electrode tab was welded to an aluminum plate as an external positive electrode current collector, and the negative electrode tab was welded to a copper plate serving as an external negative electrode current collector, then they were inserted into an exterior package of an aluminum laminate film, and the film was welded so as to form an injection portion. A non-aqueous electrolyte solution was injected from the injection portion, and then the injection portion was sealed, thereby obtaining a battery.

The non-aqueous electrolyte solution was prepared by dissolving lithium hexafluorophosphate (LiPF₆) serving as an electrolyte at a concentration of 1 mol/L with respect to a mixed solvent in which ethylene carbonate (EC) and ethyl methyl carbonate (EMC) were mixed at EC:EMC=1:3 (volume ratio).

### [X-Ray Diffraction Measurement of Lithium Transition Metal Composite Oxide]

The lithium transition metal composite oxide obtained in each of the examples and the comparative examples was coarsely pulverized by an agate mortar so as to attain an average particle size (D50) of 43 μm or less, and was then subjected to X-ray diffraction measurement using an X-ray diffractometer (“SmartLab” provided by Rigaku). In view of an XRD profile obtained by the X-ray diffraction measurement, it was confirmed that the lithium transition metal composite oxide had a lamellar crystal structure.

An integrated intensity ratio (I₀₀₃/I₁₀₄) was calculated from an integrated intensity ratio of diffraction peaks at a (003) plane and a (104) plane in the XRD profile. Results are shown in Table 2.

The value of the half width of intensity I₀₀₃ of the diffraction peak at the (003) plane in the XRD profile was used as a breadth B of the diffraction peak in the following Scherrer equation so as to calculate a crystallite size L₀₀₃ at the (003) plane. Results are shown in Table 2.

L₀₀₃=Kλ/B cos θ, where

K represents a Scherrer constant, λ represents the wavelength [nm] of the X-ray, B represents the breadth [rad] of the diffraction peak, and 0 represents a Bragg angle [rad].

### [Measurement of Average Particle Size (D50) of Lithium Transition Metal Composite Oxide]

The lithium transition metal composite oxide obtained in each of the examples and the comparative examples was coarsely pulverized in an agate mortar so as to attain an average particle size (D50) of 43 μm or less, and the average particle size (D50) of the lithium transition metal composite oxide was measured in accordance with JIS Z 8825:2022, Particle size analysis—Laser diffraction methods. As a laser diffraction type particle size distribution measurement apparatus, “MT3000II” provided by Microtrac was used. Isopropyl alcohol (IPA) was used as a solvent for wet type dispersion. Results are shown in Table 2.

### [Measurement of Discharging Capacity and Calculation of Capacity Retention in Charging/Discharging Cycles]

The battery obtained in each of the examples and the comparative examples was charged to 4.2 V at a current rate of 0.1 C as an activation charging process. Thereafter, a discharging process was performed at 0.1 C to 3.0 V, and a discharging capacity [mAh/g] on this occasion was measured. Results are shown in Table 2.

Then, a charging/discharging process in which the battery was charged to 4.2 V at a current rate of 1 C, was then discharged to 3.0 V at 1 C, and was thereafter rested for 10 minutes was regarded as one cycle, and this was repeated 10 cycles. The discharging capacities obtained by the discharging processes in the charging/discharging processes of the first cycle and the tenth cycle were measured, and a capacity retention [%] was calculated based on the following formula. Results are shown in Table 2.

$$Capacity retention [ \% ] = ( discharging capacity in the tenth cycle / discharging capacity in the first cycle ) \times 100$$

TABLE 2

| | Secondary Particles | | | Evaluation | |
|---|---|---|---|---|---|
| | Integrated | Crystallite | Average Particle | Discharging | Capacity |
| | Intensity Ratio | Size L₀₀₃ | Diameter | Capacity | Retention |
| | I₀₀₃/I₁₀₄ | [nm] | (D50) [nm] | [mAh/g] | [%] |
| Example 1 | 1.06 | 1021 | 13.65 | 223 | 97.4 |
| Example 2 | 1.12 | 1097 | 13.88 | 223 | 97.2 |
| Example 3 | 1.15 | 1058 | 13.95 | 223 | 96.9 |
| Example 4 | 1.18 | 1194 | 13.82 | 219 | 95.3 |
| Comparative | 1.10 | 847 | 13.73 | 210 | 96.2 |
| Example 1 | | | | | |
| Comparative | 1.12 | 891 | 13.84 | 212 | 96.3 |
| Example 2 | | | | | |
| Comparative | 1.15 | 933 | 13.90 | 216 | 95.1 |
| Example 3 | | | | | |
| Comparative | 1.18 | 991 | 13.88 | 218 | 94.5 |
| Example 4 | | | | | |
| Comparative | 1.20 | 1128 | 14.13 | 223 | 89.2 |
| Example 5 | | | | | |
| Comparative | 1.20 | 1365 | 13.93 | 225 | 88.0 |
| Example 6 | | | | | |

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A positive electrode active material comprising secondary particles in each of which primary particles are aggregated, wherein
each of the secondary particles is a lithium transition metal composite oxide having a lamellar crystal structure,
the lithium transition metal composite oxide includes Li, Ni, Mn, Co, and M, the M being one or more metal elements selected from a group consisting of Mg, Ca, Al, Ti, V, Cr, Fe, Cu, Zn, Zr, Nb, Mo, Ta, and W,
a molar ratio of the Li, the Ni, the Mn, the Co, and the M is Li:Ni:Mn:Co:M=a:x:y:z:t, where the a, the x, the y, the z, and the t satisfy 1.0≤a≤1.3, x+y+z=1, 0.25≤x≤0.9, 0≤y≤0.6, 0≤z≤0.6, and 0≤t≤0.1, an integrated intensity ratio (I₀₀₃/I₁₀₄) of diffraction peaks of the secondary particle in an X-ray diffraction method is 1.05 to 1.19, and
a crystallite size L₀₀₃ of the secondary particle is 1000 Å or more.

2. The positive electrode active material according to claim 1, wherein the integrated intensity ratio (I₀₀₃/I₁₀₄) is 1.16 or less.

3. The positive electrode active material according to claim 1, wherein the M includes the W.

4. The positive electrode active material according to claim 1, wherein an average particle size (D50) of the secondary particles is 3 to 20 μm.

5. The positive electrode active material according to claim 1, wherein in each of the secondary particles, 50 or more primary particles are aggregated.

6. A positive electrode using the positive electrode active material according to claim 1.

7. A non-aqueous electrolyte secondary battery comprising the positive electrode according to claim 6.
